(19) United States
(12) Patent Application Publication
(10) Pub. No.: US 2013/0220895 A1
(43) Pub. Date: Aug. 29, 2013

(54) APPARATUS AND METHOD FOR PLANT RESINS EXTRACTION

(71) Applicants: Richard Ashley Tucker, Mountain View, CA (US); Thomas Anthony Lynch, IV, Los Altos, CA (US)

(72) Inventors: Richard Ashley Tucker, Mountain View, CA (US); Thomas Anthony Lynch, IV, Los Altos, CA (US)

(21) Appl. No.: 13/406,360

(22) Filed: Feb. 27, 2012

(51) Int. Cl. B07B 1/06

(52) U.S. Cl. 209/235

(57) ABSTRACT

Apparatus and method for extracting plant resin particulates by sifting plant materials using micron mesh filter media that can be quickly and easily installed and replaced.

### FIELD OF THE INVENTION

This invention relates to the processing of plant materials, and more particularly to an apparatus for effective and efficient extraction of resin particulates from plant materials and an improved method for extracting resins from plant materials.

### BACKGROUND OF THE INVENTION

Typical methods for extracting plant resins from bulk plant material utilize chemical solvents along with filter media to dissolve and separate the desired resins from the other plant materials. These methods require additional processes to remove the chemicals from the collected resins. These extraction chemicals may constitute substantial costs and liabilities to provide, handle, apply and dispose of, and risk altering the resins in undesirable ways or producing undesirable residue.

Another typical method for extracting plant resins utilizes a water bath along with filter media to suspend and then separate the desired resins from the other plant materials. This method requires additional processes to remove the water from the collected resins after percolation through the filters.

Other typical methods avoid dissolving or wetting the resins by using dry sifting methods, separating the desired resin particulates from the other bulk materials by forcing them through sieve or mesh filters.

All of these methods use various combinations of temperature, pressure, agitation and time to facilitate the extraction processes. The filter media tends to clog during extraction with these methods, thus frequent filter cleaning or filter replacement is generally required to maintain process efficiency, typically at significant costs in time and/or materials.

### SUMMARY OF THE INVENTION

The primary objective of the present invention is to provide an apparatus to offer an improved method for effectively and efficiently extracting resin particulates from plant materials such as dried flowers, stems, roots, and the like.

A particular benefit of the invention is to reduce the complexity and costs in time and materials for cleaning, replacing or changing the filter media.

The invention provides an extracting apparatus comprising a disc-shaped micron-mesh filter assembly that quickly and easily installs onto a ring-shaped filter housing, that together quickly and easily install into in a cylindrical container. The filter assembly becomes locked into the apparatus, pinched between the filter housing and the container wall. The filter assembly is likewise quickly and easily removable for replacement purposes. This configuration minimizes the time required for replacing filters and utilizes a minimal amount of materials for the filter assembly, particularly the filter media, to minimize initial and replacement filter costs.

The invention provides an effective dry sifting plant resin extraction method that does not require water or other solvents. Although wet extraction is not precluded for gaining the benefits of easily changeable and economic filter media, a dry method has the benefits of not requiring subsequent drying or removal of solvents from the extracted resins and eliminates a mode of contamination. The quick and economical filter change aspect of the invention facilitates replacing clogged filter media and also facilitates the use of multiple filtration steps of increasingly fine mesh size.

### DESCRIPTION OF THE DRAWINGS

FIG. 1 is a main view of the filter assembly.

FIG. 2 is a partial cross-section of the filter assembly.

FIG. 3 is a main view of the filter housing.

FIG. 4 is a cross-section of the filter housing.

FIG. 5 is a partial cross-section of the housing and filter assembly.

FIG. 6 is a side view cross-section of the extractor assembly apparatus.

### DETAILED DESCRIPTION OF THE BEST MODE

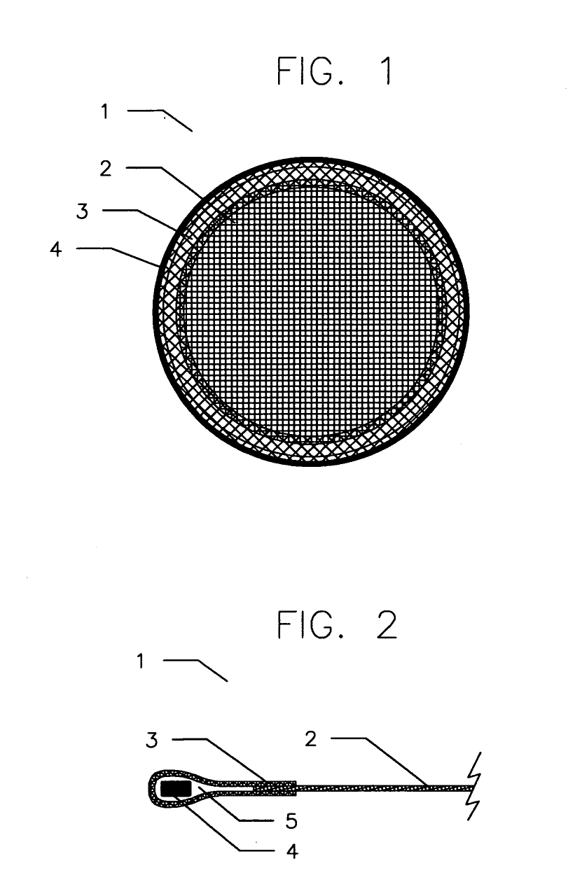

Referring to FIG. 1 and FIG. 2, according to a preferred mode of the present invention, shown is a disc-shaped filter assembly 1 composed of micron mesh filter media 2 attached to edge material 3 that encloses an elastic band 4 in a hem 5. Alternately, the filter media can directly enclose the band thus forming its own hem and eliminating the edge material. The band shown is elastic material of any appropriate profile, but does not have to be elastic to function properly, and alternately it may be molded or welded onto the edge material or the filter media rather than enclosed in a hem, or it may be provided as a separate component of the filter assembly utilizing no hem.

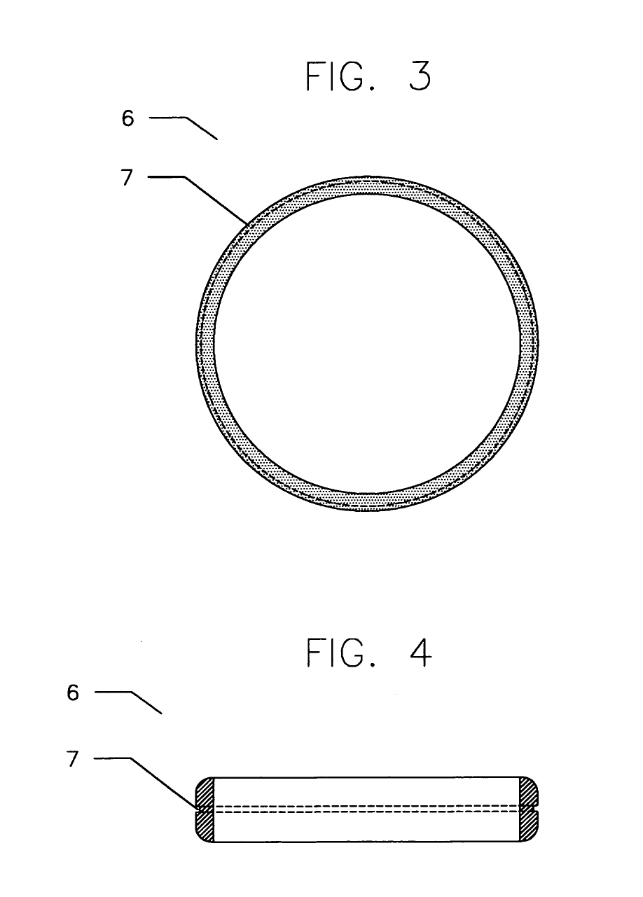

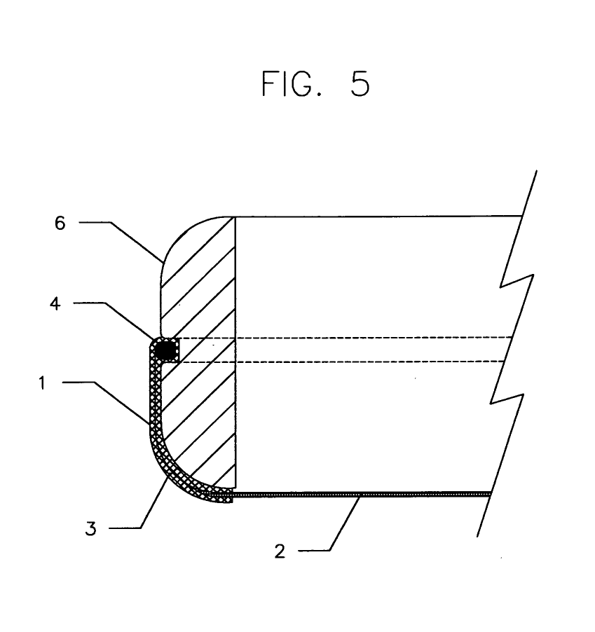

FIG. 3 and FIG. 4 show a ring-shaped filter housing 6 with a groove 7 in the outer periphery. The groove is not required for basic function, but in this preferred mode facilitates holding the filter assembly in place during installation. The band of the filter assembly when installed on the filter housing engages the groove to help retain the filter media in position. The groove is shown in a central position but can be positioned more toward an edge.

FIG. 5 shows a detail cross-section of the housing and filter assembly 8, that consists of the filter assembly 1 installed onto the filter housing 6, covering one annular side, with the band 4 around the outer periphery. As the band only assists in holding the filter assembly on the filter housing during further installation, a properly shaped filter assembly can be used without use of a band.

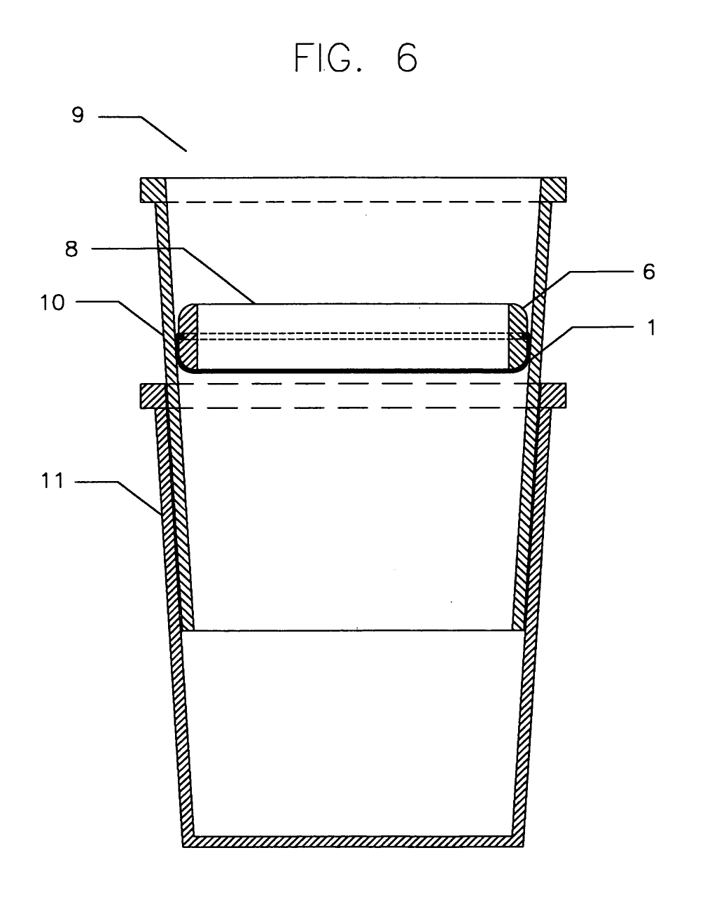

FIG. 6 shows the extractor assembly 9 consisting of the housing and filter assembly 8 inserted into a main container 10 that is a tapered cylinder without a bottom, inserted into a similar secondary container 11 that has a bottom. The filter assembly 1 becomes locked in place, pinched between the filter housing 6 and the main container, and yet is easily removed when desired. While two containers are shown in this preferred mode of the present invention, one container is sufficient to gain the core benefits, with or without a bottom. And although tapered cylinders are shown for the containers, variations with straight sided cylinders are possible.

This arrangement allows the filter assembly to be quickly removed from the apparatus for cleaning, replacement or changing filter mesh size, and quickly and easily reinstalled. This design also allows the filter to be comprised of a minimal amount of filter media and other materials, to minimize initial and replacement costs.

Another aspect of the invention is that the tapered cylindrical container can be as simple and economical as a standard industrial bucket, typically of five- or seven-gallon size, although custom containers are not precluded. In one aspect of the invention the main container is a standard industrial bucket with tapered sides with its bottom removed, thus serving primarily to hold the ring and filter assembly. This main container is inserted into a secondary standard bucket used as an outer container that retains its bottom and collects the extracted resins in a clean, contained and convenient manner. With this form of the apparatus the extracted resins can be accessed for further handling simply by removing the main container from the secondary bucket without disturbing the installed ring and filter assembly.

Although gravity can be used to force the resin particulates through the filter, which may be assisted by the flow of liquid in cases of wet extraction, more effective extraction requires application of additional forces. The present invention anticipates utilizing agitation, in the form of mechanical or sonic vibration or aeration, which may be combined with a physical weight on top of the plant material to further improve extraction throughput.

The invention also anticipates using temperature to improve extraction throughput with the use of cold temperatures to make the plant material more brittle and less tacky and thus more efficiently separated through the filter. Whereas chilled solutions are used in some wet methods, one aspect of the present invention utilizes frozen carbon dioxide (dry ice) to provide the cold temperatures without wetting the plant material. After cooling the plant material during the resin extraction the dry ice evaporates into the atmosphere without consequence with adequate venting and leaves no residue and an unaltered extract. Additionally, the dry ice can serve as the previously mentioned physical weight on top of the plant material and can also provide an abrasive element to further improve extraction throughput.

The preferred method of the present invention starts with a certain size micron mesh filter assembly, the mesh size chosen for the resin particulates to be extracted, installed on the filter housing and the housing and filter assembly installed in the main container of the apparatus, inserted into the secondary container. A quantity of the plant material to have the resins extracted is spread-out on top of the filter media inside the container. A quantity of dry ice is layered on top of the plant material. This loaded apparatus is then agitated for a period of time. Plant resin particulates are thereby forced through the filter and collected at the bottom of the container. The collected resins can be further processed through finer mesh filter media if desired. The non-extracted plant materials remaining above the filter can be removed for further processing or disposal.

The invention claimed is:

1. An apparatus for extracting resin from plant materials, composed of an easily removable disc-shaped filter assembly consisting in most part of micron mesh filter media, installed on a ring-shaped filter housing, said housing and filter assembly inserted into a cylindrical main container.

2. An apparatus as in claim 1 in which said filter assembly includes a band attached to the outer periphery.

3. An apparatus as in claim 2 in which said band is elastic.

4. An apparatus as in claim 1 in which said filter housing includes a groove in the outer periphery.

5. An apparatus as in claim 1 in which said container is tapered.

6. An apparatus as in claim 1 in which said container is an industrial bucket.

7. An apparatus as in claim 1 in which said container is bottomless.

8. An apparatus as in claim 7 in which said container is inserted into a cylindrical secondary container.

9. A method of extracting certain sized plant resin particulates using an apparatus composed of a disc-shaped filter assembly consisting in most part of micron mesh filter media, installed on a ring-shaped filter housing, and said housing and filter assembly is held in a cylindrical main container.

10. A method of claim 9 wherein said micron mesh filter media is sized to match a plant's resin particulate size.

11. A method of claim 9 wherein said container is bottomless and is inserted into a secondary cylindrical container.

12. A method of claim 9 wherein plant materials are spread on top of said filter media in said apparatus.

13. A method of claim 12 wherein frozen CO2 is layered on top of said plant materials.

14. A method of claim 12 or claim 13 wherein said plant materials are agitated.

15. A method of claim 12 or claim 13 wherein said plant materials are agitated for a minimum of five minutes.

16. A method of claim 9 wherein the plant's resin particulates smaller than the micron mesh filter media size collect under said filter assembly.

17. A method of claim 11 wherein the plant's resin particulates smaller than the micron mesh filter media size collect at the bottom of said secondary container.
